(19) United States
(12) Patent Application Publication
(10) Pub. No.: US 2018/0290328 A1
(43) Pub. Date: Oct. 11, 2018

(54) GUIDING SYSTEM FOR A HANDHELD ELECTRIC SAW

(71) Applicant: Yishai ZULER, Beer-Tuvia (IL)

(72) Inventor: Yishai ZULER, Beer-Tuvia (IL)

(21) Appl. No.: 15/944,857

(22) Filed: Apr. 4, 2018

(30) Foreign Application Priority Data
Apr. 9, 2017 (IL) 251675

(51) Int. Cl. B27B 9/04; B27B 27/02

(52) U.S. Cl. CPC B27B 9/04; B27B 9/02; B27B 27/02

(57) ABSTRACT

A saw guide adapted to guide a cutting device as to make a straight cut in an object, comprising a base unit; a longitudinal track connected to the base unit; a track rider connected to the track adapted to be ridden longitudinally across the track; a coupling element with a first side connected to the track rider and a second side connected to the cutting device; and a stabilization handle attached to the base unit adapted to stabilize the saw guide when clung to an edge of the object.

### FIELD OF THE INVENTION

The present invention relates to the field of handheld power tool accessories. More particularly, the invention relates to a guide for an electric handheld cutting device.

### BACKGROUND OF THE INVENTION

Using a handheld cutting device, such as a circular saw, to saw a straight cut in wooden boards and planks can result in an imperfect straight cut. To solve this imperfection, a woodworker can use a rip guide which is a bar which runs in parallel to the blade of the saw and guides the saw along the edge of the wooden board or plank.

Unfortunately rip guides are not sufficient in every case, inasmuch as the edge of the plank or board might be uneven and have bumps which will cause the cut not to be straight, let alone cases in which a cut is required that is not parallel to or near the edge of the plank or board.

Several other saw guides known in the art comprise an elongated track which can be attached to a wooden board or plank in any location thereby allowing a woodworker to make straight cuts regardless of the edge of the board or plank. Saw guides typically comprise a plate that is connected to the track, to which a saw can be connected and guided along the track while sawing.

These saw guides are large, due to the need for a track that is long enough to guide a saw over large planks of wood and a plate connecting the saw to the track, and can therefore not fit in a standard tool box. Furthermore, the saw guides typically need to be attached tightly to the cut plank by attaching means, such as clamps or braces, in order to ensure the guide will not shift during sawing. In addition the thickness of the plate connecting the saw to the track elevates the saw away from the wood and therefore reduces the effective depth of cut. The process of connecting a plate to a saw is time consuming and due to the size of the plate it must be removed when using the saw without the guide.

Woodworkers sometimes use an improvised guide by using a speed square or making their own jig. Both methods work in a similar manner, requiring the woodworker to keep the saw parallel to the guide. While these methods are cost efficient due to utilization of tools which exist in a typical woodworker's arsenal, it's difficult to create a straight cut thereby, as the saw tends to move away from the guide during sawing.

Some of the existing cutting devices that have a rail do not allow cutting very close to the edge, due to the rail (that requires space) and the distance between the blade and the side of the shoe of the cutting device.

Other cutting devices use an external plate. However, the external plate pushes the blade to be in a higher position and therefore, reduces the cutting depth.

It is therefore an object of the invention to provide a saw guide comprising elements with a smaller size than the elements of the prior art saw guides.

It is another object of the invention to provide a saw guide that can be operated without being attached to an object tightly by other attaching means.

It is yet another object of the invention to provide a saw guide suitable for a plurality of saws and other cutting devices.

It is yet another object of the invention to provide a saw guide that can be easily and quickly setup.

Other objects and advantages of this invention will become apparent as the description proceeds.

### SUMMARY OF THE INVENTION

A saw guide adapted to guide a cutting device as to make a straight cut in an object, comprising a base unit; a longitudinal track connected to the base unit; a track rider connected to the track adapted to be ridden longitudinally across the track; a coupling element with a first side connected to the track rider and a second side connected to the cutting device; and a stabilization handle attached to the base unit adapted to stabilize the saw guide when clung to an edge of the object.

According to an embodiment the saw guide is adapted to perform straight cuts that are cross, rip, miter, bevel or compound cut.

According to another embodiment the base unit further comprises a fastening element configured to be released for setting a desired position of the track, and configured to be pressed against the base unit thereby fastening the track to the base unit at the position.

According to another embodiment the base unit further comprises degree marks of a protractor adapted to indicate the position that the proximal side of the track should be in order to achieve a desired angle.

According to another embodiment the stabilization handle comprises a horizontal section adapted to be clung to the top side of the object and a vertical section adapted to be clung to the proximal edge of the object.

According to another embodiment the bottom side of the horizontal section comprises a slip surface.

According to another embodiment the track rider is adapted to be detachedly placed on the top side of the track.

According to another embodiment a first side of the coupling element is configured to be reversibly attached to the track rider and the second side of the coupling element is configured to be reversibly attached to a rip fence connection apparatus of a cutting device.

According to another embodiment the saw guide can be taken apart into small pieces that do not exceed a predefined size.

According to another embodiment the track comprises one or more track joints and one or more mediating elements, each side of each mediating element adapted to be reversibly attached to a track joint thereby assembling a track longer than the predefined size.

According to another embodiment the saw guide is adapted to be clung to the supported side of the object.

According to another embodiment the side of the track to which a cutting device is attached is the same side as the user's handedness (i.e. on the right side for right-handed users and on the left side for left-side users).

According to another embodiment the saw guide further comprises a locking element adapted to hold the track adjacent to the handle.

In another aspect the present invention relates to a coupling element for connecting a cutting device to a track of a saw guide with a first side configured to be reversibly connected to the track and a second side configured to be reversibly attached to a rip fence connection apparatus of a cutting device.

According to another embodiment the second side of the coupling element is configured to pass through a left hand side rip fence opening of a right handed cutting device to a right hand side rip fence opening of the cutting device.

### BRIEF DESCRIPTION OF THE DRAWINGS

In the drawings:

FIG. 1 is a top view of a saw guide, attached to an object according to an embodiment of the invention;

FIG. 2 is a top view of the saw guide of FIG. 1, wherein the track is set at an obtuse angle with respect to the stabilization handle;

FIG. 3 is a top view of the saw guide of FIG. 1, wherein the track is set at a sharp angle with respect to the stabilization handle;

FIG. 4 is a perspective view of the saw guide of FIG. 1;

FIG. 5 is a bottom view of the saw guide of FIG. 1 in an obtuse angle configuration;

FIG. 6 schematically illustrates a side section view of a coupling element attached to a track rider according to an embodiment of the invention;

FIG. 7 is an enlarged view of a base unit according to an embodiment of the invention;

FIG. 8 schematically illustrates a side section view of a fastening element in a closed configuration according to an embodiment of the invention;

FIG. 9 is an exploded view of the saw guide of FIG. 1.

FIG. 10 schematically illustrates a perspective view of a jigsaw connected to a saw guide according to an embodiment of the invention.

FIGS. 11A-11C schematically illustrate a circular saw connected to a saw guide according to an embodiment of the invention.

FIGS. 12A-12C schematically illustrate the saw guide of FIG. 1 in a storage configuration, according to an embodiment of the invention.

### DETAILED DESCRIPTION OF THE INVENTION

A saw guide adapted to guide a cutting device, such as a circular saw, while making a straight cut through planks of wood and wooden boards.

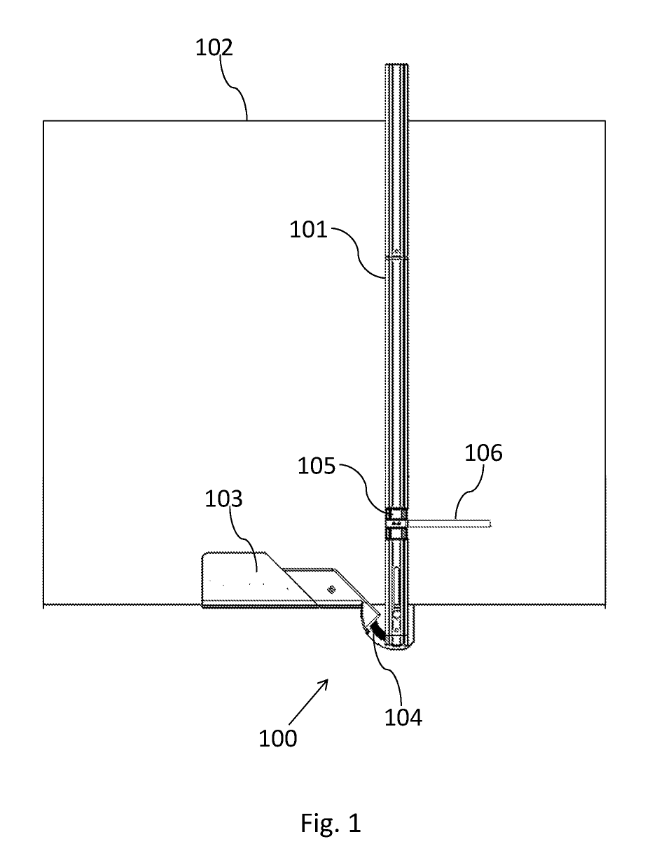

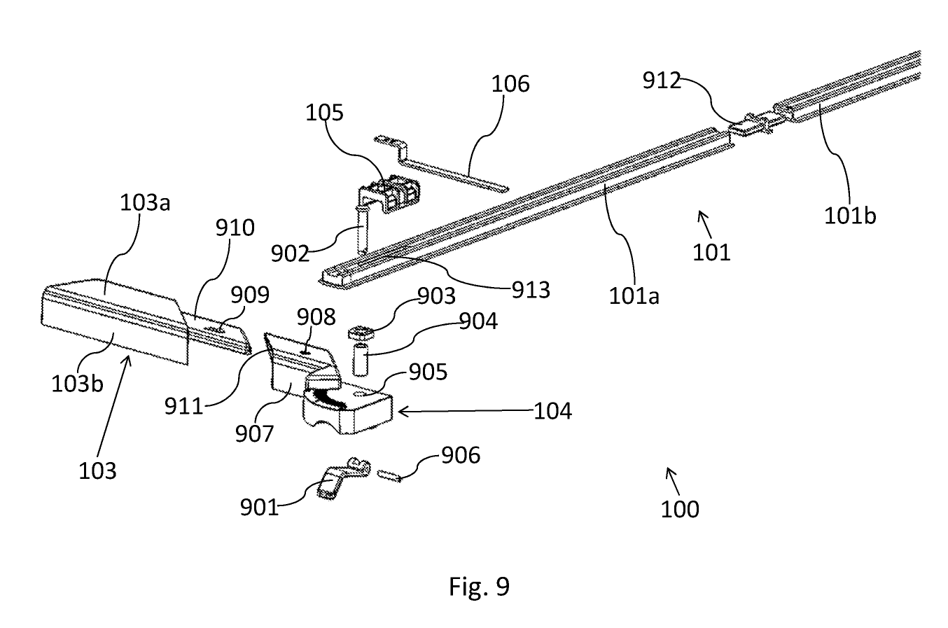

FIG. 1 is a top view of a saw guide 100, coupled to an object 102 according to an embodiment of the invention. Saw guide 100 comprises a track 101, a stabilization handle 103, a base unit 104, a track rider 105 and a coupling element 106. FIG. 9 is an exploded view of saw guide 100.

Track 101 is a U shaped track, adapted to allow track rider 105 to reciprocate upon the track proximally and distally. Accordingly, coupling element 106 can be reversibly attached on one side to a cutting device, such as a circular saw, and on the other side to track rider 105, as will be described in detail hereinafter, thereby allowing a guided linear movement of an activated cutting device while maintaining a straight line of cut.

Now referring to FIG. 9, fastening element 901 is adapted to fasten track 101 when being in its closed state by pressing pin 902 against the top side of track 101 and therefore pressing track 101 tightly against base unit 104. Pin 902 passes through an elongated opening 913 in track 101, through a flat square washer 903 and through a cylindrical element 904 to the bottom side of base 104 where pin 902 is attached to the axis side of fastening element 901 by securing pin 906. When fastening element 901 is pressed towards base unit 104, pin 902 is pulled downward, consequently pressing track 101 against base unit 104. When fastening element 901 is released, i.e. pressed away from base unit 104, pin 902 is loosened and track 101 can be shifted. Square washer 903 is adapted to fit into the bottom side of track 101 and assist in preventing rotation of the track 101. FIG. 8 schematically illustrates a side section view of fastening element 901 in a closed configuration, wherein pin 902 is pulled downward by the element, pressing on the top side of track 101.

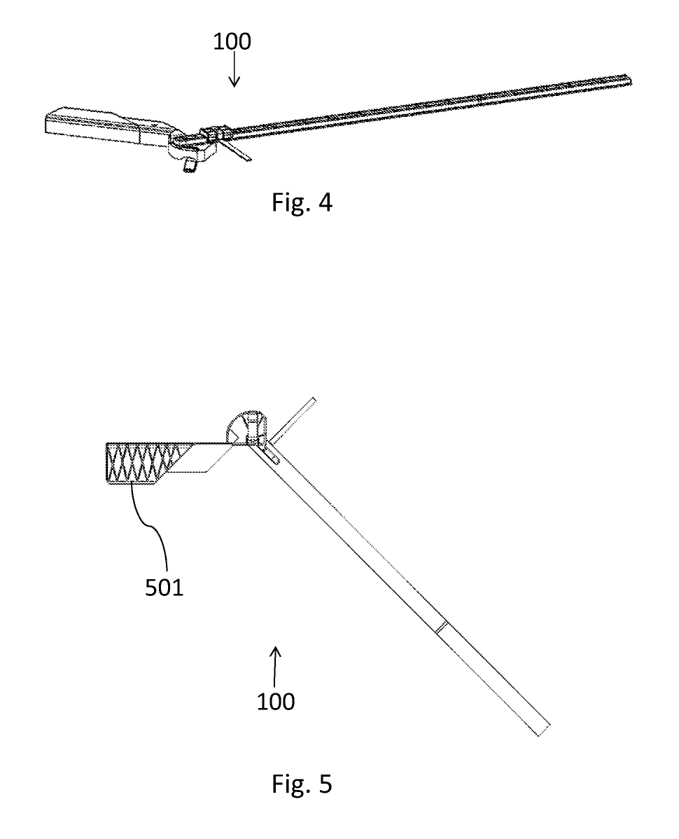

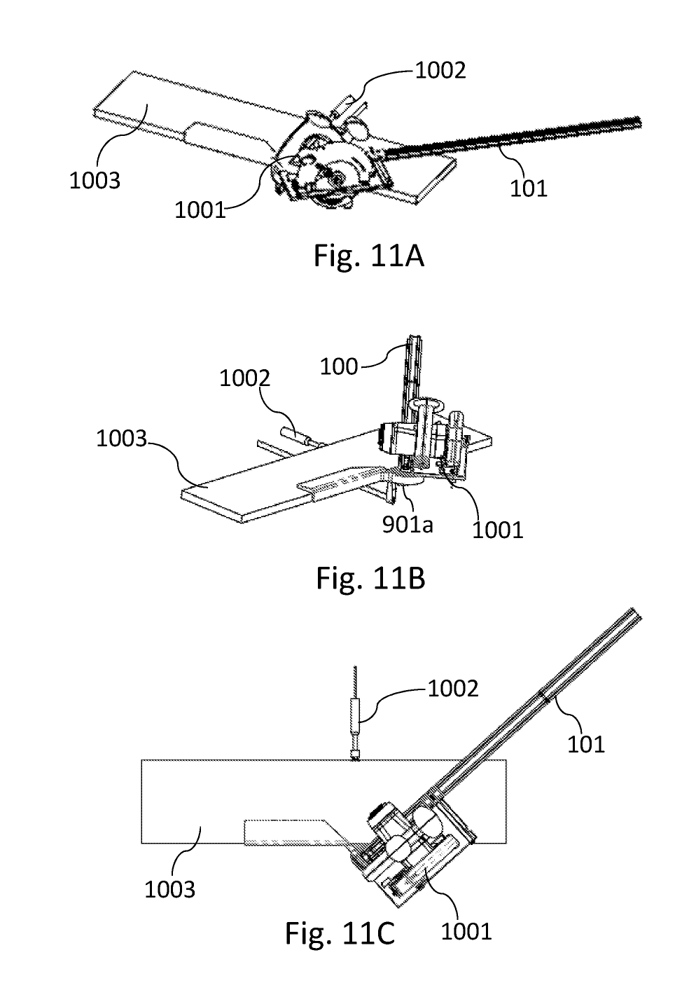

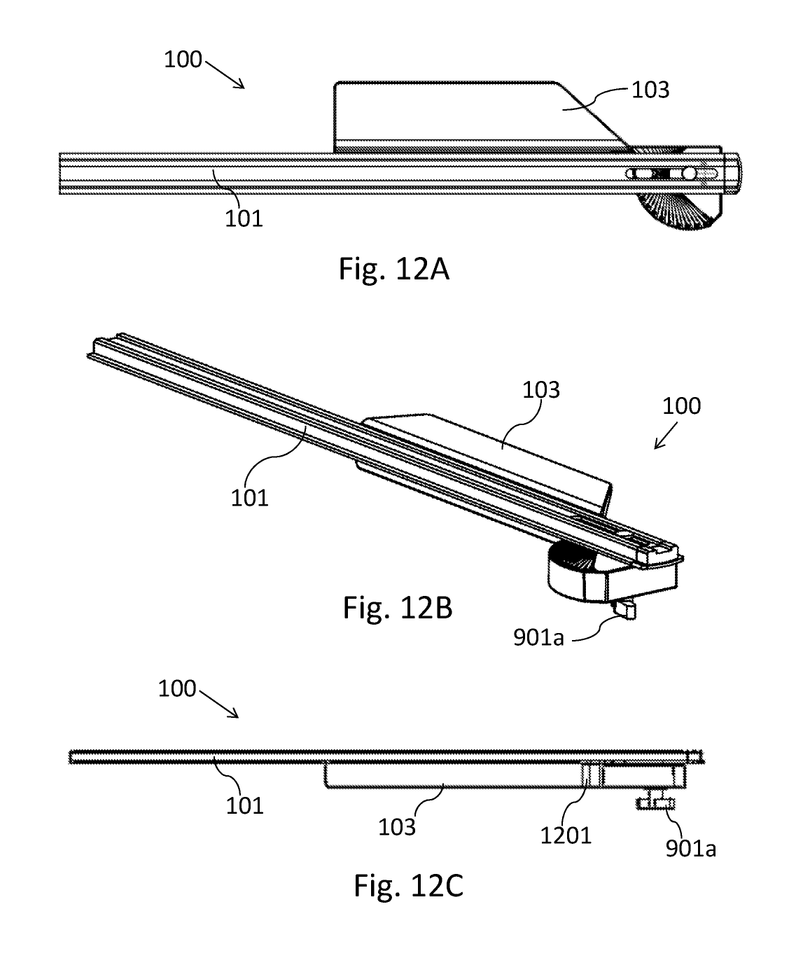

In the embodiment illustrated in FIGS. 4, 5, 8, 9 and 10 the fastening element 901 is a latch. According to another embodiment of the invention, and as illustrated in FIGS. 11B, 12B and 12C, the fastening element is a screw butterfly 901a. In this embodiment track 101 can be fastened and held tightly against base unit 104 by screwing butterfly 901a to the bottom side of base unit 104. When butterfly 901a is unscrewed the positioning of track 101 relative to base unit 104 can be changed.

Base unit 104 comprises a stabilization side 907 which comprises a hollow flat channel into which stabilization handle 103 is slid in order to be attached to base unit 104. Opening 908 in stabilization side 907 of base unit 104 is adapted to receive locking element 909 on the insertion section 910 of handle 103. Insertion opening 911 of base unit 104 is adapted to receive insertion section 910, upon which locking element 909 is held by opening 908, thereby attaching handle 103 to base unit 104 securely. In order to withdraw handle 103 from base unit 104 locking element 909 can be pressed downward via opening 908, thereby releasing the locking element from opening 908 allowing insertion section 910 to be withdrawn from insertion opening 911.

Stabilization handle 103 further comprises a horizontal section 103a and a vertical section 103b. Horizontal section 103a is configured to be clung to the top of object 102, while vertical section 103b is adapted to be clung to the proximal edge of object 102. When connected to base 104, stabilization handle 103 is adapted to stabilize saw guide 100 when clung at the edge of the object 102 and held in place by a user. This profitably allows fast and easy setup of the saw guide without the need of clamps or other attaching means throughout the whole process of making a cut. It is noted that as there are eventually two sides of a cut wood—a supported side that is situated on a supporting stand and a sawn side that is sawn away from the supported side, saw guide 100 is positioned on the supported side, i.e. on the left side of a cutting device.

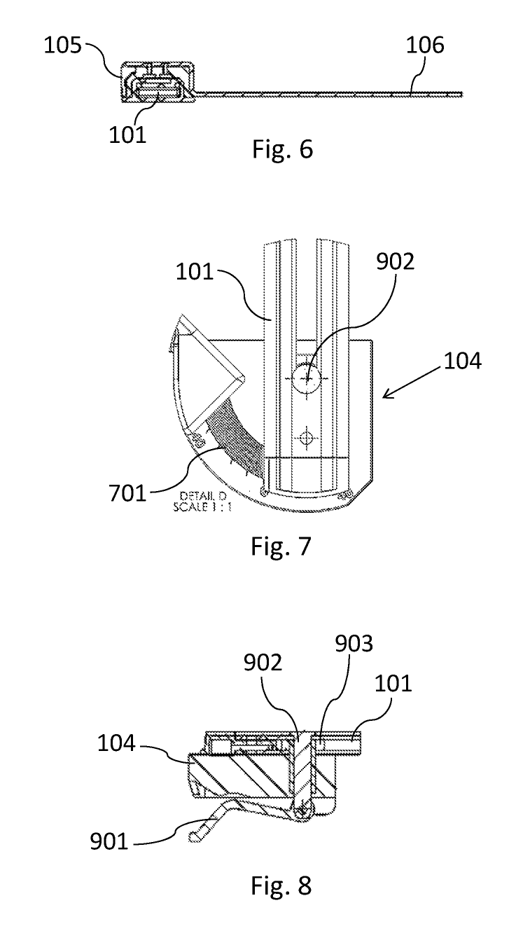

Track rider 105 is not fixedly attached to the track 101, but rather is adapted to be detachedly placed upon the track allowing the track rider 105 to slide longitudinally (i.e. distally and proximally) along track 101. Coupling element 106 is attached to track rider 105 on one side. FIG. 6 schematically illustrates a side section view of coupling element 106 attached to track rider 105. The other side of coupling element 106 is configured to be attached to a rip fence connection apparatus (not shown) of a cutting device, as is described hereinafter. Accordingly coupling element 106 is adapted to be connected and disconnected from track 101 simply by raising the cutting device to which it is connected. This profitably allows fast, safe and easy setup for performing a straight cut.

Typical cutting devices comprise two openings for connecting a rip fence, each on an opposite side of the shoe of the cutting device, as is well known in the art of cutting devices such as circular saws. Considering a typical right handed circular saw in which the blade is on the right hand side of the motor, a traditional rip fence is inserted through the right hand side rip fence opening to the left hand side opening. In contrast, the coupling element 106 of the present invention is inserted (considering the same typical saw and the same two openings) through the left hand side rip fence opening to the right hand side opening, while having the left side of coupling element 106 attached to track rider 105.

According to an embodiment of the invention, saw guide 100 can be disassembled into small pieces that can be inserted into a conventional toolbox. Accordingly each piece must be of a size that does not exceed a predefined size, e.g. 30 cm or 50 cm long, depending on the size of the toolbox. On the other hand track 101 is required to be long enough to allow guiding cuts which are longer than the predefined size. The track therefore comprises one or more track joints, 101a and 101b in FIG. 9, each joint no longer than the predefined length, such as 30 cm, wherein the track joints are interconnected by mediating element 912 that is adapted to be inserted into insertion openings in track joints 101a and 101b, mediating element 912 further adapted to hold track joints on either side in place by insertion of a locking element (not shown in the figures), e.g. an Allen screw or a locking element similar to locking element 909.

FIGS. 12A-12C schematically illustrate saw guide 100 in a storage configuration, according to an embodiment of the invention. In this embodiment the fastening element (e.g. 901a) is released, thereby allowing track 101 to be shifted to a position adjacent to stabilization handle 103. According to an embodiment, when adjacent to handle 103, track 101 engages a locking element (numeral 1201 in FIG. 12C) and is held adjacent to handle 103.

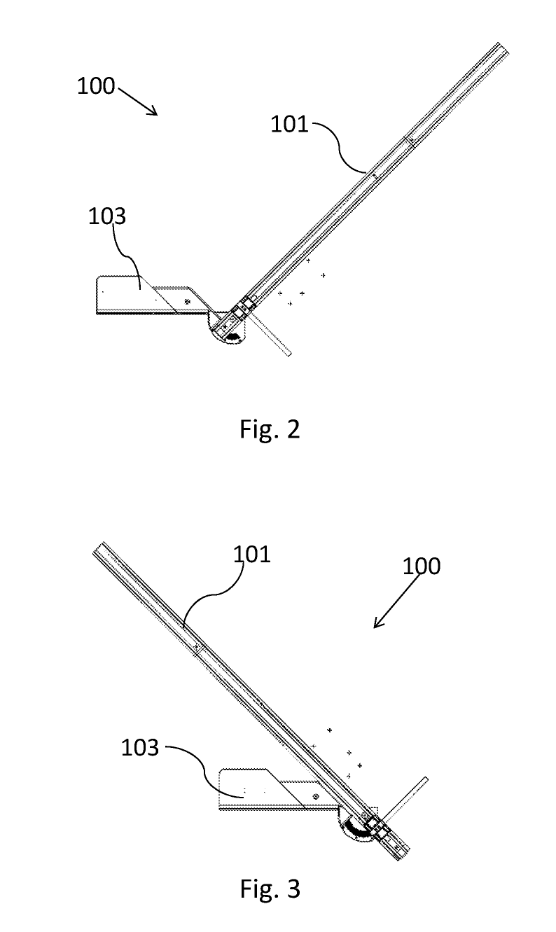

According to an embodiment of the invention, saw guide 100 is adapted to guide a cutting device through a straight cut performed in an angle with respect to the proximal edge of object 102, i.e. perform a miter cut. Accordingly, FIG. 7 is an enlarged view of base unit 104 which comprises degree marks 701 of a protractor that provide indication of the position that the proximal side of track 101 should be in order to achieve a miter cut. The saw guide can provide an angle which is up to 48 degrees to each direction of perpendicular to the edge of object 102, i.e. between 42 and 138 degrees with respect to the edge of object 102. In order to set saw guide 100 at a desired angle, fastening element 901 is released, the track is set to the desired angle, e.g. 0 degrees indicating a cut perpendicular to the edge of object 102, and finally fastening element 901 is pressed against base unit 104. FIG. 2 is a top view of saw guide 100, wherein track 101 is set at an obtuse angle with respect to the stabilization handle 103, and FIG. 3 is a top view of saw guide 100, wherein track 101 is set at a sharp angle with respect to the stabilization handle 103.

When setting an angle, coupling element 106 rotates perpendicular to track 101. When the angle is obtuse (such as in FIG. 2) the right side of coupling element 106 comes closer to the user, while in sharp angles the right side of coupling element 106 moves away from the user. Consequently the initial contact point at which a cutting device starts cutting an object changes according to the angle of the track 101. In order to efficiently utilize the length of track 101, opening 913 (in FIG. 9) is provided as to allow adjustment of the longitudinal (i.e. linear) position of track 101 with reference to base unit 104, thereby providing adjustment of the initial contact point in order to allow a user to, for instance, have track 101 positioned forward (i.e. away from the user) when in obtuse angles (as is illustrated in FIG. 2 wherein pin 902 is seen through the near side of opening 913) and positioned backward (i.e. pulled towards the user) when in sharp angles (as is illustrated in FIG. 3 wherein pin 902 is seen through the far side of opening 913). By this the maximum length of track 101 can be used in any angle. FIG. 5 is a bottom view of saw guide 100 in an obtuse angle configuration. The bottom side of the horizontal section of stabilization handle 103 comprises a slip surface 501 for assisting in preventing the saw guide from moving after being positioned in the desired position on the object 102.

Bevel cuts can be performed with tools such as circular saw that have the possibility to tilt the saw blade. A cutting device performing a bevel cut can be connected to the saw guide in the same manner as a cutting device performing a cross or miter cut. It is also possible to make a compound cut which is a combination of both bevel cut and miter cut.

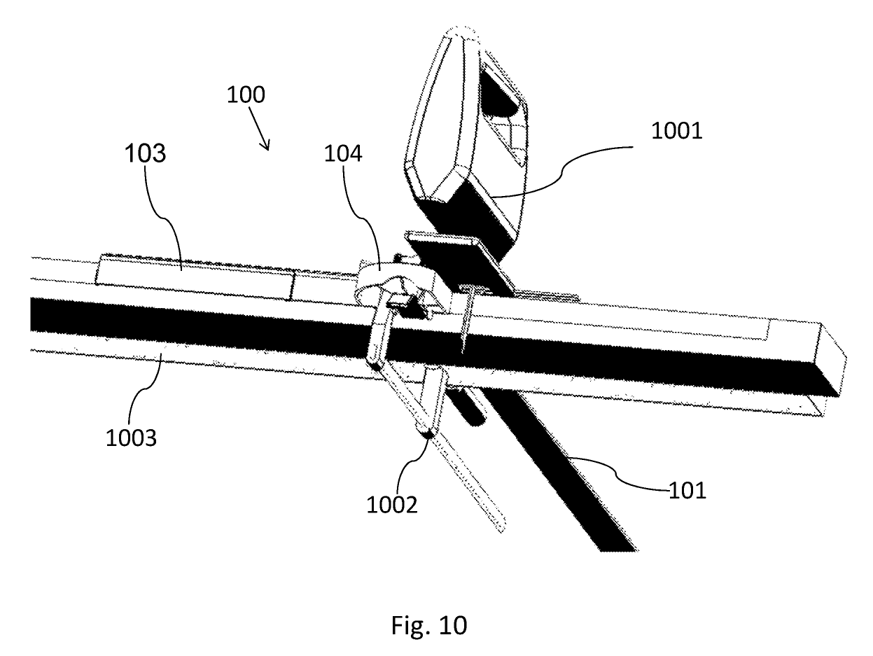

According to another embodiment, a clamp can be used to connect saw guide 100 to a supported side of the wood being cut. FIG. 10 shows a perspective view of a jigsaw 1001 connected to saw guide 100. Clamp 1002 is used to connect the saw guide to object 1003. The proximal side of clamp 1002 engages the base unit 104, while the distal side of clamp 1002 engages the distal side of object 1003, thereby supporting guide 100 strongly to the object, and obviating the need for hand-supporting stabilization handle 103. FIGS. 11A-11C show a circular saw 1101 connected to a saw guide 100 according to an embodiment of the invention. A clamp 1102 is used to saw guide 100 to an object 1103.

Several advantages have been shown in the saw guide of the present invention. The main advantage is the use of a coupling element advantageously allowing fast, easy and safe connection and disconnection of a cutting device with the guide. Other advantages include the obviation of a plate and linear adjustment of the initial contact point, which together result in a device smaller than the prior art in addition to the ability to use a built in cut position indicator of the saw. The way the saw is connected to the rail (only at the front part of the saw body) allows using a shorter rail comparing to standard saw guides (in which the connection is along the entire length of the saw body). Therefore using the saw guide proposed by the present invention allows shortening the rail by essentially most of the length of the saw body.

Another advantage is the positioning of the track on the supported side of the wood plank which is both safer and more convenient than having a track on the non-supported side. Saw guide 100 can be attached to the rip guide apparatus of any cutting device and is therefore the cutting devices with which the saw guide can be used is not limited.

It is noted that although embodiments of the invention have been described and illustrated as suitable for a right-handed cutting device, the present invention is not limited to being suitable for right-handed cutting devices, and can be configured, mutatis mutandis, to suit left-handed cutting devices and left-handed users.

Although embodiments of the invention have been described by way of illustration, it will be understood that the invention may be carried out with many variations, modifications, and adaptations, without exceeding the scope of the claims.

1. A saw guide adapted to guide a cutting device for making a straight cut in an object, comprising:
a. a base unit;
b. a longitudinal track connected to the base unit;
c. a track rider connected to the track adapted to be ridden longitudinally across the track;
d. a coupling element with a first side connected to the track rider and a second side connected to the cutting device; and
e. a stabilization handle attached to the base unit adapted to stabilize the saw guide when clung to an edge of the object.

2. A saw guide according to claim 1, wherein the straight cut is a cross, rip or miter cut.

3. A saw guide according to claim 1, wherein whenever the cutting device has tilting capability, the straight cut is a bevel or compound cut.

4. A saw guide according to claim 1, wherein the base unit further comprises a fastening element configured to be released for setting a desired position of the track, and configured to be pressed against the base unit thereby fastening the track to the base unit at the position.

5. A saw guide according to claim 1, further comprising a screw butterfly for fastening and releasing the track to and from the base unit.

6. A saw guide according to claim 1, wherein the base unit further comprises degree marks of a protractor adapted to indicate the position that the proximal side of the track should be in order to achieve a desired angle.

7. A saw guide according to claim 1, wherein the stabilization handle comprises a horizontal section adapted to be clung to the top side of the object and a vertical section adapted to be clung to the proximal edge of the object.

8. A saw guide according to claim 7, wherein the bottom side of the horizontal section comprises a slip surface.

9. A saw guide according to claim 1, wherein the track rider is adapted to be detachedly placed on the top side of the track.

10. A saw guide according to claim 1, wherein a first side of the coupling element is configured to be reversibly attached to the track rider and the second side of the coupling element is configured to be reversibly attached to a rip fence connection apparatus of a cutting device.

11. A saw guide according to claim 1, wherein the saw guide can be disassembled into small pieces that do not exceed a predefined size.

12. A saw guide according to claim 11, wherein the track comprises one or more track joints and one or more mediating elements, each side of each mediating element adapted to be reversibly attached to a track joint thereby assembling a track longer than the predefined size.

13. A saw guide according to claim 1, wherein the saw guide is adapted to be clung to the supported side of the object.

14. A saw guide according to claim 1, wherein a cutting device is attached to the right or to the left of the track.

15. A saw guide according to claim 1 further comprising a locking element adapted to hold the track adjacent to the handle.

16. A saw guide according to claim 1, wherein the track comprises an elongated opening for adjusting the track linearly.

17. A coupling element for connecting a cutting device to a track of a saw guide with a first side configured to be reversibly connected to the track and a second side configured to be reversibly attached to a rip fence connection apparatus of a cutting device.

18. A coupling element according to claim 17 wherein the second side of the coupling element passes through a left hand side rip fence opening of a right handed cutting device to a right hand side rip fence opening of the cutting device.
